(19) United States
(12) Patent Application Publication
(10) Pub. No.: US 2022/0115645 A1
(43) Pub. Date: Apr. 14, 2022

(54) SILICON ELECTROLYTE COMPOSITE PARTICLES, COMPOSITIONS AND USES IN LITHIUM ION BATTERIES

(71) Applicant: Nanostar, Inc., New Orleans, LA (US)

(72) Inventors: Shiva Adireddy, Metairie, LA (US); Jonathan Goodman, New Orleans, LA (US)

(21) Appl. No.: 17/358,869

(22) Filed: Jun. 25, 2021

Related U.S. Application Data
(60) Provisional application No. 63/016,510, filed on Apr. 28, 2020.

(51) Int. Cl. H01M 4/36; H01M 10/0562; H01M 4/62; H01M 10/0525; H01M 4/38

(52) U.S. Cl. CPC H01M 4/366; H01M 10/0562; H01M 4/625; H01M 2004/027; H01M 4/386; H01M 2300/0068; H01M 10/0525

(57) ABSTRACT

Porous particulates for use in lithium ion batteries are described. The porous materials include silicon active materials carried in a carbon matrix that includes a solid-electrolyte phase. The combined matrix of the carbon and solid-electrolyte carries silicon nanoparticles and conducts lithium ions and electrons. The manufacture and use are further described.

### CROSS-REFERENCE TO RELATED APPLICATIONS

This application claims benefit of provisional application No. 63/016,510, filed on Apr. 28, 2020, which is incorporated herein by reference.

### FIELD

Aspects of the present disclosure relate to the structure of particles which include anode-active nanoparticles and solid electrolytic materials and their use in anodes in lithium ion batteries.

### BACKGROUND

Lithium-ion (Li⁺) secondary or rechargeable batteries are now the most widely used secondary battery systems for portable electronic devices. However, the growth in power and energy densities for lithium ion battery technology has stagnated in recent years as materials that exhibit both high capacities and safe, stable cycling have been slow to be developed. Much of the current research effort for the next generation of higher energy capacity materials has revolved around using small or nanoparticulate active material bound together with conductive agents and carbonaceous binders.

There is a current and growing need for higher power and energy density battery systems. The power requirements for small scale devices such as microelectromechanical systems (MEMS), small dimensional sensor systems, and integrated on-chip microelectronics exceed the power densities of current Li⁺ based energy storage systems. Power densities of at least 1 J/mm² are desired for effective function for such systems, and current energy densities for Li⁺ thin film battery systems are about 0.02 J/mm². Three dimensional architectures for battery design can improve the areal power density of Li⁺ secondary batteries by packing more active material per unit area without employing thicker films that are subject to excessive cycling fatigue. Three-dimensional Lithium-ion battery architectures also increase lithium ion diffusion by maximizing the surface area to volume ratio and by reducing diffusion lengths.

The current state-of-the-art for anode electrodes in lithium ion batteries includes the use of high surface area carbon materials. However, the capacity of any graphitic carbon, carbon black, or other carbonaceous material is limited to a theoretical maximum of 372 mAh/g and about 300 mAh/g in practice because carbon electrodes are usually formed of carbon particles mixed with a polymeric binder pressed together to form a bulk electrode. To store charge, Li⁺ intercalates between the planes of sp² carbon atoms and this C—Li⁺—C moiety is reduced. In addition, the maximum number of Li⁺ that can be stored is one per every six carbon atoms (LiC₆). While the capacity of graphitic carbon is not terribly high, the intercalation process preserves the crystal structure of the graphitic carbon, and so cycle life can be very good.

A more recent and promising option for anode materials is silicon (Si). In contrast to the intercalative charge storage observed in graphite, Si forms an alloy with lithium. Silicon-based negative electrodes are attractive because their high theoretical specific capacity of about 4200 mAh/g, which far exceeds than that of carbon, and is second only to pure Li metal. This high capacity comes from the conversion of the Si electrode to a lithium silicide which at its maximum capacity has a formula of Li₂₂Si₆, storing over 25 times more Li per atom than carbon. The large influx of atoms upon alloying, however, causes volumetric expansion of the Si electrode of over 400%. This expansion causes strain in the electrode, and this strain is released by formation of fractures and eventual electrode failure. Repeated cycling between LiₓSi_{y} and Si thus causes crumbling of the electrode and loss of interconnectivity of the material. For example, 1 μm thick Si film anodes have displayed short cyclability windows, with a precipitously capacity drop after only 20 cycles. Accordingly, new structures for silicon compositions are needed to support these anodic materials.

### SUMMARY

A first aspect is a porous particulate for use in a lithium ion battery where the porous particulate can include a porous heterogeneous matrix that includes a carbon phase, a solid-electrolyte phase, and a plurality of pores; and a plurality of silicon nanoparticles carried by and embedded in the porous heterogeneous matrix and having at least a portion adjacent to the plurality of pores.

A porous heterogenous matrix may function to provide a desirable pathway between the porous particulate (i.e., the carbon and/or the solid-electrolyte phases) and the silicon nanoparticles. The porous heterogeneous matrix can include a continuous or discontinuous matrix of carbon and a continuous or discontinuous matrix of solid-electrolyte embedded, interlinked, or affixed between the continuous or discontinuous matrix of carbon so that the plurality of pores are formed therebetween. The porous heterogeneous matrix may have continuous and/or discontinuous matrices of carbon and/or solid-electrolyte that are arranged so that the silicon nanoparticles can be embedded within heterogenous mixture of carbon and solid electrolyte. The porous heterogeneous matrix may include clusters of the carbon intermittent with a discontinuous or continuous matrix of solid electrolyte so that the plurality of pores are formed between the carbon and the solid-electrolyte with varying pore diameters and/or sizes. The porous heterogeneous matrix may include a discontinuous phase of solid-electrolyte coating a continuous or discontinuous matrix of carbon. The porous heterogenous matrix may include a continuous matrix of solid-electrolyte phase that separates the discontinuous phase of carbon so that a portion or most of the individual carbons are free of contact with other carbons and/or the silicon nanoparticles can interact with the carbons with higher conductivity. The heterogenous matrix may include clusters of solid-electrolyte spread throughout a continuous phase or matrix of carbon so that pockets of solid-electrolyte are dispersed unevenly proximate to the pores. The porous heterogenous matrix may have continuous and/or discontinuous portions among the carbon and/or the solid-electrolyte so that the silicon nanoparticles embedded and/or carried within have an even distribution or have portions where the silicon nanoparticles are clustered. The silicon nanoparticles may be evenly distributed or clustered throughout the solid electrolyte and/or the carbon phases to form the porous heterogenous matrix. The silicon nanoparticles may have portions that contact the carbon phase or may be free of contact with the carbon phase within the porous heterogenous matrix. The silicon nanoparticles may be interspersed, embedded, and/or carried within the solid-electrolyte phase in the porous heterogenous matrix so that conductivity between the carbon phase and the silicon nanoparticles in improved.

A second aspect is a process of preparing a porous particulate for use in a lithium ion battery, where the process can include forming a plurality of admixture microparticulates, having an average diameter of about 1 μm to about 100 μm, the admixture particulates include about 5 wt. % to about 80 wt. % (dry basis) of a carbon matrix precursor, about 5 wt. % to about 50 wt. % (dry basis) of a plurality of solid-electrolyte nanoparticles, and about 5 wt. % to about 90 wt. % (dry basis) of a plurality of silicon nanoparticles; and then reducing the carbon matrix precursor to provide a carbon phase.

A third aspect is a process of preparing a porous particulate for use in a lithium ion battery, where the process can include forming a plurality of admixture microparticulates, having an average diameter of about 1 μm to about 100 μm, the admixture particulates include about 5 wt. % to about 80 wt. % (dry basis) of a carbon matrix precursor, about 5 wt. % to about 50 wt. % (dry basis) of a plurality of solid-electrolyte nanoparticles, and about 5 wt. % to about 90 wt. % (dry basis) of a plurality of silicon nanoparticles; and then crosslinking the carbon matrix precursor to provide a carbon phase.

### BRIEF DESCRIPTION OF THE FIGURES

For a more complete understanding of the disclosure, reference should be made to the following detailed description and accompanying drawing figures.

FIG. 1 is a first schematic for the preparation of the porous particulates described herein.

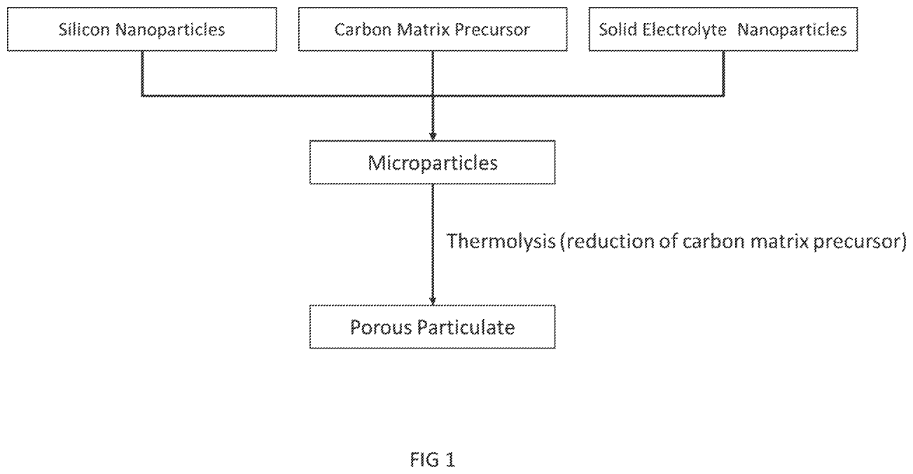

FIG. 2 is a second schematic for the preparation of the porous particulates described herein.

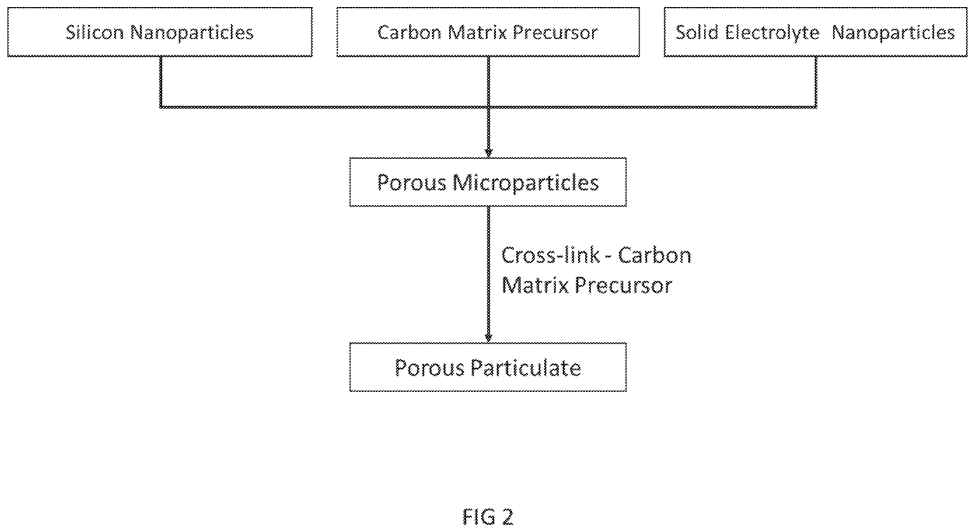

While specific examples are illustrated in the figures, with the understanding that the disclosure is intended to be illustrative, these examples are not intended to limit the disclosure described and illustrated herein.

### DETAILED DESCRIPTION

Objects, features, and advantages of the present disclosure will become apparent from the following detailed description. It should be understood, however, that the detailed description and the specific examples, while indicating specific examples of the disclosure, are given by way of illustration only, since various changes and modifications within the spirit and scope of the disclosure will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

A first aspect is a porous particulate for use in a lithium ion battery, which preferably includes a porous heterogeneous matrix and a plurality of silicon nanoparticles. The porous heterogeneous matrix can include, consist essentially of, or consists of a carbon phase, a solid-electrolyte phase, and a plurality of pores. The plurality of silicon nanoparticles are preferably carried by and embedded in the porous heterogeneous matrix while having at least a portion of said nano particles being adjacent to the plurality of pores. Adjacent meaning that at least some portion of the silicon particle surface forms the contours of the pore (i.e., said particle surface is directly exposed to the pore cavity and if filled with gas directly in contact with the gas of the pore).

Within the porous interior of the porous particulates, the solid electrolyte may be filled with thin layers of solid electrolytes. For example, the solid electrolytes may fill the porous particulates with a thin layer having a thickness of about 0.3 nm or more, about 10 nm or more, or about 50 nm or more. The thin layer may have a thickness of about 1 micrometer or less, about 500 nm or less, or about 100 nm or less.

In a preferable instance, the porous particulate has a particle electrical conductivity in a range of about 10⁻⁴ to about 10⁵ S/cm, about 10⁻³ to about 10⁵ S/cm, about 10⁻² to about 10⁵ S/cm, about 10⁻³ to about 10⁴ S/cm, about 10⁻³ to about 10³ S/cm, about 10⁻² to about 10⁵ S/cm, about 0.1 to about 10⁵ S/cm, or about 1 to about 10⁵ S/cm. Still further, the porous particulate, preferably, has a particle ionic conductivity in a range of about 10⁻⁶ to about 10⁻¹ S/cm, about 10⁻⁵ to about 10⁻¹ S/cm, about 10⁻⁴ to about 10⁻¹ S/cm, or about 10⁻³ to about 10⁻¹ S/cm. More preferably the particle ionic conductivity is greater than about 10⁻⁵, about 10⁻⁴, about 10⁻³, of about 10⁻²S/cm.

In some examples, the porous particulate may have a density that varies depending on the size of the pores and the components used therein. The porous particulate may have a density of about 0.5 g/cm³ or more, about 0.9 g/cm³ or more, or about 1.3 g/cm³ or more. The porous particulate may have a density of about 2.5 g/cm³ or less, about 2.1 g/cm³ or less, or about 1.7 g/cm³. The porous particles may include pore formers that can be evaporated to vary the density. For example, the pore formers may be low-temperature polymers. The low temperature polymers may evaporate at about 50 degrees Celsius or more, about 90 degrees Celsius or more, or about 130 degrees Celsius or more. The low-temperature polymers may evaporate at about 250 degrees Celsius or less, about 210 degrees Celsius or less, or about 170 degrees Celsius or less.

In one instance, the solid-electrolyte phase of the carbon matrix provides a lithium ion pathway from a surface of the particulate to the plurality of silicon nanoparticles. That is, the solid-electrolyte reduces the resistivity and/or improves the ionic conduction from the surface of the particulate to the silicon nanoparticles. In one example, the solid-electrolyte phase includes ion channels. In another example, the solid-electrolyte phase includes cation-anion pairs.

The solid-electrolyte phase can be embedded in the carbon phase and/or a portion adjacent to the carbon phase and/or affixed to the carbon phase. In a preferable instance, the solid-electrolyte phase is embedded in and affixed to the carbon phase. Herewith, the solid-electrolyte phase can be affixed to the carbon phase by chemical bonding. Preferably, the silicon nanoparticles can have a portion adjacent to the solid-electrolyte phase. More preferably, the silicon nanoparticles are ionically connected to the solid-electrolyte phase. Even more preferably, the solid-electrolyte phase and the silicon nanoparticles are in sufficient contact that lithium ions can flow between the solid-electrolyte phase and the silicon nanoparticles. Herewith, sufficient contact means that the interfacial resistance to ion transfer is less than about 100, 50, 25, 10 5, or 1 Ohm/cm².

In some examples, the solid electrolyte phase may cover the carbon phase to form core shells where the shell comprises a solid electrolyte phase and the core is a carbon phase. The shell may have a thickness of about 10 nm or more, about 100 nm or more, or about 500 nm or more. The shell may have a thickness of about 10 micrometers or less, about 5 micrometers or less, or about 1 micrometer or less. The core may have a diameter of about 1 nm or more, about 100 nm or more, or about 500 nm or more. The core may have a diameter of about 50 micrometers or less, about 10 micrometers or less, or about 1 micrometers or less.

In one instance, the carbon phase can include, consist essentially of, or consist of carbon. In one example, the carbon phase can be a soft carbon; in another example, the carbon phase can be a hard carbon. In still another example, the carbon phase is an admixture of soft and hard carbon. Preferably, the carbon phase is electronically conductive; that is, the carbon phase conducts electrons to and from the silicon nanoparticles carried within the porous particulate to a surface of the porous particulate. In a particulate instance, the carbon phase can have an electrical conductivity in a range of about 10⁻⁴ to about 10⁵ S/cm, about 10⁻³ to about 10⁵ S/cm, about 10⁻² to about 10⁵ S/cm, about 10⁻³ to about 10⁴ S/cm, about 10⁻³ to about 10³ S/cm, about 10⁻² to about 10⁵ S/cm, about 0.1 to about 10⁵ S/cm, or about 1 to about 10⁵ S/cm.

In another instance, the porous particulate can further include a conductive carbon. The conductive carbon can be selected from carbon nanotubes, carbon nanofibers, graphene, graphene oxide, reduced graphene oxide, mesocarbon microbeads, or a mixture thereof. Specific examples of conductive carbon can include Super P (e.g., MTI), Super C65 (e.g., IMERY), Super C45 (e.g., IMERY), TIMREX KS6 (e.g., MTI), and KS6L (e.g., IMERY). Preferably, the porous particulate includes about 1 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, or 10 wt. % of the conductive carbon. In certain instances, the conductive carbon is embedded in, adhered to, and/or affixed to the carbon phase and this admixture of conductive carbon and the carbon phase has an electrical conductivity in a range of about 10⁻⁴ to about 10⁵ S/cm, about 10⁻³ to about 10⁵ S/cm, about 10⁻² to about 10⁵ S/cm, about 10⁻³ to about 10⁴ S/cm, about 10⁻³ to about 10³ S/cm, about 10⁻² to about 10⁵ S/cm, about 0.1 to about 10⁵ S/cm, or about 1 to about 10⁵ S/cm.

The silicon nanoparticles may be amorphous or crystalline. The silicon nanoparticles can include greater than about 70 wt. %, 75 wt. %, 80 wt. %, 85 wt. %, 90 wt. %, about 95 wt. %, about 98 wt. %, about 99 wt. %, about 99.5 wt. %, or about 99.9 wt. % silicon. In one instance, the silicon nanoparticles can consist essentially of silicon. In another instance, the silicon nanoparticles can consist of silicon. In one example, the silicon nanoparticles can include hydrogenated silicon (a-Si:H). In another example, the silicon nanoparticles can include n-doped or p-doped silicon.

In yet another example, the silicon nanoparticles include a silicon alloy. The silicon alloy can be a binary alloy (silicon plus one alloying element), can be a tertiary alloy, or can include a plurality of alloying elements. The silicon alloy is understood to include a majority silicon. A majority silicon means that the nanoparticles have a weight percentage that is greater than about 50% (50 wt. %) silicon, preferably greater than about 60 wt. %, 70 wt. %, 80 wt. %, 90 wt. %, 95 wt. %, 96 wt. %, 97 wt. %, 98 wt. %, 99 wt. %, or 99.5 wt. % silicon. The alloying element can be, for example, an alkali metal, an alkaline-earth metal, a Group 13 to 16 element, a transition metal group element, a rare earth group element, or a combination thereof, and not Si. The alloying element can be, for exmaple, Li, Na, Mg, Ca, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, B, Al, Ga, In, Ge, Sn, P, As, Sb, Bi, S, Se, Te, or a combination thereof. In one instance, the alloying element can be lithium, magnesium, aluminum, titanium, vanadium, chromium, manganese, iron, cobalt, nickel, copper, or a mixture thereof. In another instance, the alloying element can be selected from copper, silver, gold, or a mixture thereof. In still another instance, the silicon alloy can be selected from a SiTiNi alloy, a SiAlMn alloy, a SiAlFe alloy, a SiFeCu alloy, a SiCuMn alloy, a SiMgAl alloy, a SiMgCu alloy, or a combination thereof.

As the term alloy typically infers a homogeneous distribution of the alloying element(s) in the base material, silicon, the silicon nanoparticles can further include a heterogeneous distribution of alloying elements in the nanoparticles. In some instances, these alloy elements form intermetallics in the silicon nanoparticles. An intermetallic (also called an intermetallic compound, intermetallic alloy, ordered intermetallic alloy, and a long-range-ordered alloy) is an alloy that forms a solid-state compound exhibiting defined stoichiometry and ordered crystal structure; here, within the silicon nanoparticle composition (e.g., a NiSi intermetallic within Si)

The silicon nanoparticles, preferably, have an average diameter of less than about 1,000 nm, 900 nm, 800 nm, 700 nm, 600 nm, 500 nm, 400 nm, 300 nm, or 250 nm. In another instance, the silicon nanoparticles have an average diameter of from about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, or 100 nm to about 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, or 1,000 nm. In specific instances, the silicon nanoparticles have an average diameter of about 50 nm to about 1,000 nm, about 50 nm to about 800 nm, about 50 nm to about 750 nm, about 50 nm to about 700 nm, about 50 nm to about 650 nm, about 50 nm to about 600 nm, about 50 nm to about 550 nm, about 50 nm to about 500 nm, about 50 nm to about 450 nm, about 50 nm to about 400 nm, about 50 nm to about 350 nm, about 50 nm to about 300 nm, about 100 nm to about 750 nm, about 100 nm to about 600 nm, about 100 nm to about 500 nm, about 100 nm to about 400 nm, or about 100 nm to about 300 nm. In one instance, silicon nanoparticles have a spherical morphology. In another instance, the silicon nanoparticles can have a plate-like morphology.

The silicon nanoparticles may be coated with SiOₓ to form a core shell having a core of silicon nanoparticles and a shell of SiOₓ. Relative to the total diameter of the silicon nanoparticles described above, the shell may have a thickness of about 0.01 nm or more, about 0.1 nm or more, or about 1 nm or more. The shell may have a thickness of about 50 nm or less, about 30 nm or less, or about 10 nm or less.

The solid-electrolyte phase, preferably, is a lithium ion conductor. The solid-electrolyte phase can be a sodium ion conductor. The solid-electrolyte phase can have a perovskite structure; an anti-perovskite structure; a NASICON-type structure; a garnet-like structure; an orthosilicate garnet structure; a thio-LISICON structure; an LGPS structure; an argyrodite structure; a layered sulfide structure; or a mixture thereof. As used herein, the solid-electrolyte phase is preferably composed, made of, consists essentially or, or consists of a perovskite structured material; an anti-perovskite structured material; a NASICON-type structured material; a garnet-like structured material; an orthosilicate garnet structured material; a thio-LISICON structured material; an LGPS structured material; an argyrodite structured material; a layered sulfide structured material; or a mixture thereof.

The solid-electrolyte phase can be interspersed though the porous particulate or can be in the form of discrete crystallites or nanorods, nanowires, or mixtures thereof. In one instance, the solid-electrolyte phase does not have a discrete form but is interspersed throughout the porous particulate. In another instance, the solid-electrolyte phase is nanowires or nanorods that extend though the porous particulate.

In one example, the solid-electrolyte phase includes a perovskite structured material, alternatively just called a perovskite. The perovskite can be, for example, Li₃ₓLa_{(2/3)-x}TiO₃ (LLTO) where x is from about 0.07 to about 0.13.

In another example, the solid-electrolyte phase includes an anti-perovskite structured material, alternatively just called an anti-perovskite. The anti-perovskite can be, for example, a compound with an approximate formula of ABX₃, where A is F, Cl, Br, I, or a mixture thereof; where B is O, S, or a mixture thereof; and where X is Li. In another example, the anti-perovskite can be a compound with an approximate formula of Li_{3-2y}M_{y}XO, where M is divalent cations, for example Mg²⁺, Ca²⁺, and/or Ba²⁺; wherein X is a halide, for example F, Cl, Br, I, or a mixture thereof.

In still another example, the solid-electrolyte phase includes a NASICON type structured material. NASICON is an acronym for sodium (Na) Super Ionic CONductor and includes, for example, a compound with an approximate formula of Na₁₊ₓZr₂P₃₋ₓSiₓO₁₂ where X is from 0 to about 3. The NASICON type structured material can include a compound with an approximate formula of LiM₂(PO₄)₃; where M is selected from Zr, Ti, Hf, Ge, Sn, or a mixture thereof; a compound with an approximate formula of Li₁₊ₓRₓTi₂₋ₓ(PO₄)₃ wherein R is Al³⁺, Sc³⁺, Ga³⁺, Fe³⁺, In³⁺, Cr³⁺, or a mixture thereof, and where 0≤x≤0.5.

In yet another example, the solid-electrolyte phase includes a garnet-like structured material, alternatively just call a garnet. The garnet can be, for example, a compound with the approximate formula of Li₅La₃M₂O₁₂ where M is Nb, Ta, or a mixture thereof.

In still yet another example, the solid-electrolyte phase includes an orthosilicate garnets-like structured material, alternatively just call an orthosilicate garnet. The orthosilicate garnet can be, for example, a compound with the approximate formula of Li₇La₃Zr₂O₁₂ (LLZO).

In another example, the solid-electrolyte phase includes a thio-LISICON structured material, alternatively just call a thio-LISICON; LISICON is an acronym for lithium (Li) Super Ionic CONductor. The thio-LISICON can be, for example, a compound with the approximate formula of Li₄₋ₓM_{1-y}M′S₄ wherein M is Si, Ge, or a mixture thereof, and where M′ is P, Al, Zn, Ga, or a mixture thereof.

In yet another example, the solid-electrolyte phase includes a LGPS structure material, alternatively just called a LGPS, while LGPS typically refers to compounds composed of lithium, germanium, phosphorus, and sulfur, therein the class of materials include tin and silicon compound. The LGPS can be, for example, a compound with the approximate formula of Li₁₀GeP₂S₁₂; Li₁₀SnP₂S₁₂, Li_{10+δ}(Sn_{y}Si_{1-y})_{1+δ}P_{2-δ}S₁₂ where δ is from about 0 to about 2, and wherein y is from about 0 to 1, Li₁₁Si₂PS₁₂, Li_{9.54}Si_{1.74}P_{1.44}S_{11.7}Cl_{0.3}, or mixtures thereof.

In still another example, the solid-electrolyte phase includes an argyrodite structed material, alternatively just called an argyrodite. The argyrodite can be, for example, a compound with the approximate formula of Li₆PS₅X where X is F, Cl, Br, I, or a mixture thereof; Li₆₊ₓP₁₋ₓSiₓS₅Br where x is from about 0 to 1; Li₁₊₂ₓZn₁₋ₓPS₄, wherein x is from about 0 to 1 (LZPS). Other examples include compounds with the approximate formula of Li_{7-x-2y}PS_{6-x-y}Clₓ, where 0.8≤x≤1.7 and 0<y≤−0.25x+0.5; Li_{7-x+y}PS₆₋ₓCl_{x+y}, wherein x and y in the composition formula (1) satisfy 0.05≤y≤0.9 and −3.0x+1.8≤y≤−3.0x+5.7; Li₇₋ₓPS₆₋ₓXₓ where X is Cl or Br, and x is 0.2 to 1.8. Still other examples include compounds where the phosphorous is replaced in whole or part by boron.

In still yet another example, the solid-electrolyte phase includes a layered sulfide structured material, alternatively just called a layered sulfide. Herein, the layered sulfide can be, for example, a compound with the approximate formula of Li₃ₓ[LiₓSn₁₋ₓS₂] where x is from about 0 to about 1. Specific examples include Li[Li_{0.33}Sn_{0.67}S₂] and Li_{0.6}[Li_{0.2}Sn_{0.8}S₂]. Other examples includes compounds with the approximate formula Li⁺₍₁₂₋ₙ₋ₓ₎Bⁿ⁺X²⁻₆₋ₓY⁻ₓ, where Bⁿ⁺ is selected from the group consisting of P, As, Ge, Ga, Sb, Sn, Al, In, Ti, V, Nb and Ta; X²⁻ is selected from the group consisting of S, Se and Te; and Y⁻ is selected from the group consisting of Cl, Br, I, F, CN, OCN, SCN, and N₃, while 0≤x≤2.

When formed into a solid structure including the porous particulate that is useable within a battery, the porous particulate may be coated with varying electrolytes to improve conductivity between different components of the battery. The porous particulate may be coated with sulfides, oxides, silanes, polyvinylidene flouride-type SEI modifying polymers, or any combination thereof. The layer coating the solid structure including the porous particulate may have a thickness of about 0.5 nm or more, about 50 nm or more, or about 500 nm or more. The layer may have a thickness of about 50 micrometers or less, about 10 micrometers or less, or about 1 micrometer or less.

Another aspect is a process of preparing a porous particulate for use in a lithium ion battery. The process preferably includes forming a plurality of admixture microparticulates that individually include a carbon matrix precursor, a plurality of solid-electrolyte nanoparticles, and a plurality of silicon nanoparticles, and then reducing the carbon matrix precursor to provide a carbon phase.

In one instance, the admixture microparticulates have an average diameter of about 1 μm to about 100 μm. Preferably, admixture microparticulates have an average diameter of about 2 μm to about 75 μm, about 3 μm to about 65 μm, about 4 μm to about 50 μm, about 5 μm to about 30 μm, or about 5 μm to about 25 μm.

In another instance, the admixture microparticulates include about 5 wt. % to about 80 wt. % (dry basis) of a carbon matrix precursor. Preferably, the carbon matrix precursor is included in amounts of about 5 wt. % to about 80 wt. %, about 10 wt. % to about 75 wt. %, about 15 wt. % to about 65 wt. %, about 20 wt. % to about 60 wt. %, or about 25 wt. % to about 50 wt. % on a dry basis.

In yet another instance, the admixture microparticulates include about 5 wt. % to about 50 wt. % (dry basis) of a plurality of solid-electrolyte nanoparticles. Preferably, the solid-electrolyte nanoparticles are included in amounts of about 10 wt. % to about 50 wt. %, about 15 wt. % to about 50 wt. %, about 20 wt. % to about 50 wt. %, or about 25 wt. % to about 50 wt. % on a dry basis.

In still another instance, the admixture microparticulates include about 5 wt. % to about 90 wt. % (dry basis) of a plurality of silicon nanoparticles. Preferably, the silicon nanoparticles are included in amounts of about 5 wt. % to about 85 wt. %, about 10 wt. % to about 80 wt. %, about 15 wt. % to about 75 wt. %, about 20 wt. % to about 75 wt. %, about 25 wt. % to about 75 wt. %, about 25 wt. % to about 70 wt. %, about 25 wt. % to about 65 wt. %, about 25 wt. % to about 60 wt. % on a dry basis.

The process of preparing a porous particulate can further include, after forming the plurality of admixture microparticulates, forming a solid-electrolyte phase from the solid-electrolyte nanoparticles. In one instance, forming the solid-electrolyte phase from the solid-electrolyte nanoparticles includes sintering the solid-electrolyte nanoparticles. In another instance, forming the solid-electrolyte phase from the solid-electrolyte nanoparticles includes melting the solid-electrolyte nanoparticles. In one preferable example, the solid-electrolyte nanoparticles have a melting point depression compared to a solid-electrolyte macroparticle (i.e. a particle having a diameter of greater than about 250 nm, 500 nm, 750 nm, or 1 μm). In another instance, the solid-electrolyte phase is formed from the solid-electrolyte nanoparticles during the process of reducing the carbon matrix precursor.

In another instance, reducing the carbon matrix precursor and thereby forming a carbon matrix, decreases a carbon concentration in the microparticulate and provides a porosity to the porous particulate. In one example, reducing the carbon matrix precursor decreases a carbon concentration by about 25 wt. %, about 30 wt. %, about 35 wt. %, about 40 wt. %, about 45 wt. %, about 50 wt. %, or about 55 wt. % of the carbon matrix precursor. Reducing the carbon matrix precursor can include heating the carbon matrix precursor and/or an admixture that includes the carbon matrix precursor to a temperature in a range of about 400° C. to about 1500° C., about 500° C. to about 1200° C., about 600° C. to about 1000° C., or about 700° C. to about 1000° C. Furthermore, the reduction of the carbon matrix precursor can be undertaken under an inert (e.g., nitrogen or argon) gas or under a reducing gas or gas mixture (e.g., hydrogen, carbon monoxide, mixtures thereof with or without nitrogen and/or argon).

The plurality of admixture microparticulates can be formed by spray drying a slurry or solution of an admixture of the carbon matrix precursor, plurality of solid-electrolyte nanoparticles, and plurality of silicon nanoparticles. In one instance, the admixture is spray dried from an organic solvent, e.g., pentane, hexane, heptane, octane, nonane, decane, acetone, methylethylketone, butanol, 1-propanol, 2-propanol, ethanol, methanol, benzene, toluene, xylene, acetonitrile, tetrahydrofuran, diethylether, methylethylether, or mixtures thereof.

In another example, the plurality of admixture microparticulates can be formed from a melt of an admixture of the carbon matrix precursor, plurality of solid-electrolyte nanoparticles, and plurality of silicon nanoparticles. Herewith, the melt refers to the melting of the carbon matrix precursor.

A carbon matrix precursor is an organic compound that can be thermally processed to provide a carbon matrix. The carbon matrix precursor may be an organic compound that can be thermally reduced to provide carbon. Examples of carbon matrix precursors include phenolic resin, pitch, polyacrylonitrile, poly(furfuryl alcohol), and mixtures thereof. Preferably, the carbon matrix precursor is solid at room temperature and pressure; more preferably, the carbon matrix precursor has a melting and/or softening point that is greater than 100° C., 150° C., 200° C., 250° C., or 300° C. Other examples of useful carbon material precursors include, coal tar pitch from soft pitch to hard pitch; coal-derived heavy oil such as dry-distilled liquefaction oil; petroleum-based heavy oils including directly distilled heavy oils such as atmospheric residue and vacuum residue, crude oil, and decomposed heavy oil such as ethylene tar produced during a thermal decomposition process of naphtha and so on; aromatic hydrocarbons such as acenaphthylene, decacyclene, anthracene and phenanthrene; polyphenylenes such as phenazine, biphenyl and terphenyl; polyvinyl chloride; water-soluble polymers such as polyvinyl alcohol, polyvinyl butyral and polyethylene glycol and insolubilized products thereof; nitrogen-containing polyacrylonitriles; organic polymers such as polypyrrole; organic polymers such as sulfur-containing polythiophene and polystyrene; natural polymers such as saccharides, e.g. glucose, fructose, lactose, maltose and sucrose; thermoplastic resins such as polyphenylene sulfide and polyphenylene oxide; thermosetting resins such as phenol-formaldehyde resin and imide resin; and mixtures thereof.

The process can further include preparing the solid-electrolyte nanoparticles. In one instance, the solid-electrolyte nanoparticles can be prepared by wet milling a solid-electrolyte macroparticle. Examples of wet milling include processing the solid-electrolyte macroparticles in the presence of a solvent with a comminution mill, a trituration mill, or another mill or device adapted to reduce the size of a macroparticle to a nanoparticle. Specific comminution mills include ball mills, bead mills, pin mills, hammer mills, roller mill, and/or jet mill.

The process can further include preparing the silicon nanoparticles. In one instance, the silicon nanoparticles can be prepared by wet milling a silicon feed. Examples of wet milling include processing the silicon feed in the presence of a solvent with a comminution mill, a trituration mill, or another mill or device adapted to reduce the size of a silicon feed to a silicon nanoparticle. Specific comminution mills include ball mills, bead mills, pin mills, hammer mills, roller mill, and/or jet mill.

In still another example, the process includes providing solid-electrolyte nanoparticles which are solid-electrolyte nanowires. In still yet another example, the admixture particulates further include about 1 wt. % to about 20 wt. % (dry basis) of a conductive agent, for example, where the conductive agent is a conductive carbon.

Yet another aspect is a process of preparing a porous particulate for use in a lithium ion battery which includes forming a plurality of admixture microparticulates, and then crosslinking the carbon matrix precursor to provide a carbon phase. In this example, the carbon matrix precursor is preferably a cross-linkable polymer or polymer precursor. In one instance, the carbon matrix precursor is a polyacrylonitrile; where the polyacrylonitrile is crosslinked by heating the admixture microparticulates to a temperature in a range of about 150° C. to about 350° C., that is, to a temperature to cross link the polyacrylonitrile but not convert the polymer to a carbon. This example can preferably include solid-electrolyte nanoparticles which are solid-electrolyte nanowires. Furthermore, the admixture particulates further include about 1 wt. % to about 20 wt. % (dry basis) of a conductive agent.

While the compositions and methods of this disclosure have been described in terms of preferred examples, it will be apparent to those of skill in the art that variations may be applied to the compositions and/or methods in the steps or in the sequence of steps of the method described herein without departing from the concept, spirit and scope of the disclosure. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the disclosure as defined by the appended claims.

### Illustrative Embodiments

### Embodiment 1

A porous particulate for use in a lithium ion battery, the porous particulate comprising:

a porous heterogeneous matrix that includes a carbon phase, a solid-electrolyte phase, and a plurality of pores; and

a plurality of silicon nanoparticles, carried by and embedded in the porous heterogeneous matrix, and having at least a portion adjacent to the plurality of pores.

### Embodiment 2

The porous particulate of claim 1, wherein the solid-electrolyte phase provides a lithium ion pathway from a surface of the particulate to the plurality of silicon nanoparticles.

### Embodiment 3

The porous particulate of claim 1, wherein the solid-electrolyte phase is embedded in the carbon phase.

### Embodiment 4

The porous particulate of claim 1, wherein the solid-electrolyte phase has a portion adjacent to the carbon phase.

### Embodiment 5

The porous particulate of claim 4, wherein the silicon nanoparticles have a portion adjacent to the solid-electrolyte phase, preferably wherein the silicon nanoparticles are ionically connected to the solid-electrolyte phase.

### Embodiment 6

The porous particulate of claim 1, wherein the carbon phase consists essentially of carbon.

### Embodiment 7

The porous particulate of claim 6, wherein the carbon phase is a soft carbon.

### Embodiment 8

The porous particulate of claim 6, wherein the carbon phase is a hard carbon.

### Embodiment 9

The porous particulate of claim Error! Reference source not found., wherein the carbon phase is electronically conductive.

### Embodiment 10

The porous particulate of claim 1 further comprising a conductive carbon.

### Embodiment 11

The porous particulate of claim 7, wherein the conductive carbon is selected from the group consisting of carbon nanotubes, carbon nanofibers, C65, C45, graphene, graphene oxide, reduced graphene oxide, mesocarbon microbeads, or a mixture thereof.

### Embodiment 12

The porous particulate of claim 1, wherein the silicon nanoparticles consist essentially of silicon.

### Embodiment 13

The porous particulate of claim 1, wherein the silicon nanoparticles consist essentially of a silicon alloy.

### Embodiment 14

The porous particulate of claim 1, wherein the solid-electrolyte phase is a perovskite; an anti-perovskite; NASICON type conductor; a garnet-like phase; an orthosilicate garnets; a thio-LISICON; a LGPS; an argyrodite; a layered sulfide; or a mixture thereof.

### Embodiment 15

The porous particulate of claim 1 further comprising a particle electrical conductivity in a range of about 10⁻³ to about 10⁵ S/cm.

### Embodiment 16

The porous particulate of claim 1 further comprising a particle ionic conductivity in a range of about 10⁻⁵ to about 10⁻¹ S/cm.

### Embodiment 17

A process of preparing a porous particulate for use in a lithium ion battery, the process comprising:

forming a plurality of admixture microparticulates, having an average diameter of about 1 μm to about 100 μm, the admixture particulates include about 5 wt. % to about 80 wt. % (dry basis) of a carbon matrix precursor, about 5 wt. % to about 50 wt. % (dry basis) of a plurality of solid-electrolyte nanoparticles, and about 5 wt. % to about 90 wt. % (dry basis) of a plurality of silicon nanoparticles; and then

reducing the carbon matrix precursor to provide a carbon phase.

### Embodiment 18

The process of claim 10 further comprising, and after forming the plurality of admixture microparticulates, forming a solid-electrolyte phase from the solid-electrolyte nanoparticles.

### Embodiment 19

The process of claim 10 wherein the process of reducing the carbon matrix precursor further includes forming a solid-electrolyte phase from the solid-electrolyte nanoparticles.

### Embodiment 20

The process of claim 10 wherein reducing the carbon matrix precursor decreases a carbon concentration in the microparticulate and provides a porosity to the porous particulate.

### Embodiment 21

The process of claim 10, wherein the plurality of admixture microparticulates are formed by spray drying a solution of an admixture of a carbon matrix precursor, a plurality of solid-electrolyte nanoparticles, and a plurality of silicon nanoparticles.

### Embodiment 22

The process of claim 10 wherein the plurality of admixture microparticulates are formed from a melt of an admixture of a carbon matrix precursor, a plurality of solid-electrolyte nanoparticles, and a plurality of silicon nanoparticles.

### Embodiment 23

The process of claim 10 further comprising providing the plurality of solid-electrolyte nanoparticles by wet milling a solid-electrolyte macroparticle.

### Embodiment 24

The process of claim 10, wherein the solid-electrolyte nanoparticles are solid-electrolyte nanowires.

### Embodiment 25

The process of claim 10 further comprising providing the plurality of silicon nanoparticles by wet milling a silicon feed.

### Embodiment 26

The process of claim 10, wherein the admixture particulates further include about 1 wt. % to about 20 wt. % (dry basis) of a conductive agent.

### Embodiment 27

The process of claim 16, wherein the conductive agent is a conductive carbon.

### Embodiment 28

A process of preparing a porous particulate for use in a lithium ion battery, the process comprising:

forming a plurality of admixture microparticulates, having an average diameter of about 1 μm to about 100 μm, the admixture particulates include about 5 wt. % to about 80 wt. % (dry basis) of a carbon matrix precursor, about 5 wt. % to about 50 wt. % (dry basis) of a plurality of solid-electrolyte nanoparticles, and about 5 wt. % to about 90 wt. % (dry basis) of a plurality of silicon nanoparticles; and then

crosslinking the carbon matrix precursor to provide a carbon phase.

### Embodiment 29

The process of claim 17, wherein the carbon matrix precursor is a polyacrylonitrile; and wherein crosslinking the carbon matrix precursor includes heating the admixture microparticulates to a temperature in a range of about 150° C. to about 350° C.

### Embodiment 30

The process of claim 17, wherein the solid-electrolyte nanoparticles are solid-electrolyte nanowires.

### Embodiment 31

The process of claim 17, wherein the admixture particulates further include about 1 wt. % to about 20 wt. % (dry basis) of a conductive agent.

What is claimed:

1. A porous particulate for use in a lithium ion battery, the porous particulate comprising:
a porous heterogeneous matrix that includes a carbon phase, a solid-electrolyte phase, and a plurality of pores; and
a plurality of silicon nanoparticles, carried by and embedded in the porous heterogeneous matrix, and having at least a portion adjacent to the plurality of pores.

2. The porous particulate of claim 1, wherein the solid-electrolyte phase provides a lithium ion pathway from a surface of the particulate to the plurality of silicon nanoparticles.

3. The porous particulate of claim 1, wherein the solid-electrolyte phase is embedded in the carbon phase.

4. The porous particulate of claim 1, wherein the solid-electrolyte phase has a portion adjacent to the carbon phase.

5. The porous particulate of claim 4, wherein the silicon nanoparticles has a portion adjacent to the solid-electrolyte phase, and wherein the silicon nanoparticles are ionically connected to the solid-electrolyte phase.

6. The porous particulate of claim 1, wherein the carbon phase comprises carbon.

7. The porous particulate of claim 1 further comprising a conductive carbon selected from the group consisting of carbon nanotubes, carbon nanofibers, graphene, graphene oxide, reduced graphene oxide, mesocarbon microbeads, or a mixture thereof.

8. The porous particulate of claim 1, wherein the solid-electrolyte phase is a perovskite; an anti-perovskite; NASICON type conductor; a garnet-like phase; an orthosilicate garnets; a thio-LISICON; a LGPS; an argyrodite; a layered sulfide; or a mixture thereof.

9. The porous particulate of claim 1, further comprising:
a particle electrical conductivity in a range of about 10⁻³ to about 10⁵ S/cm; or a particle ionic conductivity in a range of about 10⁻⁵ to about 10⁻¹ S/cm.

10. A process of preparing a porous particulate for use in a lithium ion battery, the process comprising:
forming a plurality of admixture microparticulates, having an average diameter of about 1 μm to about 100 μm, the admixture particulates include about 5 wt. % to about 80 wt. % (dry basis) of a carbon matrix precursor, about 5 wt. % to about 50 wt. % (dry basis) of a plurality of solid-electrolyte nanoparticles, and about 5 wt. % to about 90 wt. % (dry basis) of a plurality of silicon nanoparticles; and
reducing the carbon matrix precursor to provide a carbon phase.

11. The process of claim 10, further comprising:
after forming the plurality of admixture microparticulates, forming a solid-electrolyte phase from the solid-electrolyte nanoparticles.

12. The process of claim 10, wherein the process of reducing the carbon matrix precursor further includes forming a solid-electrolyte phase from the solid-electrolyte nanoparticles.

13. The process of claim 10, wherein reducing the carbon matrix precursor decreases a carbon concentration in the microparticulate and provides a porosity to the porous particulate.

14. The process of claim 10, wherein the plurality of admixture microparticulates are formed by spray drying a solution of an admixture of a carbon matrix precursor, a plurality of solid-electrolyte nanoparticles, and a plurality of silicon nanoparticles, or
wherein the plurality of admixture microparticulates are formed from a melt of an admixture of a carbon matrix precursor, a plurality of solid-electrolyte nanoparticles, and a plurality of silicon nanoparticles.

15. The process of claim 10, further comprising:
providing the plurality of solid-electrolyte nanoparticles by wet milling a solid-electrolyte macroparticle; or
providing the plurality of silicon nanoparticles by wet milling a silicon feed.

16. The process of claim 10, wherein the admixture particulates further include about 1 wt. % to about 20 wt. % (dry basis) of a conductive agent.

17. A process of preparing a porous particulate for use in a lithium ion battery, the process comprising:
forming a plurality of admixture microparticulates, having an average diameter of about 1 μm to about 100 μm, the admixture particulates include about 5 wt. % to about 80 wt. % (dry basis) of a carbon matrix precursor, about 5 wt. % to about 50 wt. % (dry basis) of a plurality of solid-electrolyte nanoparticles, and about 5 wt. % to about 90 wt. % (dry basis) of a plurality of silicon nanoparticles; and
crosslinking the carbon matrix precursor to provide a carbon phase.

18. The process of claim 17, wherein the carbon matrix precursor is a polyacrylonitrile; and wherein crosslinking the carbon matrix precursor includes heating the admixture microparticulates to a temperature in a range of about 150° C. to about 350° C.

19. The process of claim 17, wherein the solid-electrolyte nanoparticles are solid-electrolyte nanowires.

20. The process of claim 17, wherein the admixture particulates further include about 1 wt. % to about 20 wt. % (dry basis) of a conductive agent.
